(19) United States
(12) Patent Application Publication
(10) Pub. No.: US 2007/0247437 A1
(43) Pub. Date: Oct. 25, 2007

(54) Capacitive touch panel with improved electrode patterns

(76) Inventors: Fu-Tien Ku, Banciao City (TW); Peter Liao, Banciao City (TW)

Correspondence Address: FRENKEL & ASSOCIATES, 3975 UNIVERSITY DR., STE. 330, FAIRFAX, VA, 22030, US

(21) Appl. No.: 11/409,425

(22) Filed: Apr. 20, 2006

(51) Int. Cl. G06F 3/041

(52) U.S. Cl. 345/173

(57) ABSTRACT

A capacitive touch panel with improved electrode patterns includes an insulating substrate, a conductive layer formed on a surface of the insulating substrate, and an electrode pattern formed on the surface of the conductive layer and disposed along the edges of the touch panel, and the electrode pattern includes a plurality of conductive silver circuits, and any row of the conductive silver circuits has a plurality of electrodes with equal length and equidistant from each other. The quantity of electrodes in each row of the conductive silver circuits is redesigned and any two adjacent conductive silver circuits are installed at corresponding positions with each other, so as to improve the linear response of an electric field and reduce the width of an electrode pattern.

### FIELD OF THE INVENTION

The present invention relates to a sensor of a touch panel, and more particularly to an electrode pattern formed at the edges of a touch panel.

### BACKGROUND OF THE INVENTION

General traditional touch panels are divided into resistive touch panels, capacitive touch panels, acoustic wave touch panels and optical touch panels according to their sensing principle, wherein the resistive touch panel is the most extensively used touch panel with the lowest price among all, but the capacitive touch panel gains increasingly attention and popularity now.

The resistive touch panel comprises an upper group and a lower group of ITO conductive layers stacked with each other. When a resistive touch panel is used, a pressure is applied to electrically connect upper and lower electrodes, and a controller detects the voltage change of the panel to compute the contact position and obtain an output position signal. For example, the related technology disclosed in U.S. Pat. No. 4,822,957 generally uses a 5-wire resistive touch panel produced by Elo Touch Company.

The capacitive touch panel forms a conductive layer (such as a metal oxide layer) on a glass substrate and then an electrode pattern on the surface of the conductive layer and finally a layer of protective film on the surface layer to produce a capacitive touch panel. The sensing principle of the capacitive touch panels resides on that a voltage is supplied to four corners of a screen, and an electrode pattern forms an electric field on the glass surface. If a user touches the panel by a finger, an electric field will be produced and driven to produce a current and lower the voltage at the contact position. A controller detects the voltage change and computes the pressing position of the finger according to the different proportions of current from the four corners. For examples, U.S. Pat. Nos. 4,198,539, 4,293,734, 4,371,746 and 6,781,579 disclose a technology applied for the capacitive touch panels.

In general, a touch panel has three major evaluation indexes: the linear response of an electric field, the level of structural complexity of an electrode and the width of an electrode pattern, wherein the linear response of an electric field is related to the accuracy of the touch panel, and the level of complexity of an electrode pattern is directly proportional to the manufacturing cost. Since the electrode pattern is distributed around the touch panel, therefore the width of the electrode pattern will directly affect the size of usable area of the touch panel. The electrode pattern comprises conductive silver circuits (also known as silver epoxy wires) on the surface of the conductive layer and a plurality of transparent electrodes formed by alternately arranging the conductive silver circuits. If there are more electrodes with a more gentle distribution, then the density or distribution of the electric charges of the whole touch panel will have a more gentle change, or else a more drastic change will occur. The linear response of the electric field near the frame area can be corrected according to this principle. On the other hand, there are more conductive silver circuits, and thus the invention can effectively improve the resistance of the conductive silver circuits at the four corners. The smaller the edge of the frame of the conductive silver circuit, the lower is the resistance. However, an excessively low resistance is not advantageous to the control and operation of the touch panel.

Therefore, finding a way of improving the linear response of the electric field of the touch panel, lowering the level of complexity of the electrode pattern, and reducing the width of the electrode pattern becomes an issue for touch panel designers and manufacturers to solve.

### SUMMARY OF THE INVENTION

The primary objective of the present invention is to provide an electron pattern for producing an even and low-voltage electric field.

To achieve the foregoing objective, the present invention discloses a capacitive touch panel comprising: an insulating substrate, a conductive layer formed on the surface of the insulating substrate, and an electrode pattern formed on the surface of the conductive layer and disposed along the edges of the touch panel. The electrode pattern includes a plurality of rows of conductive silver circuits, and any one row of the conductive silver circuits includes a plurality of electrodes having the same length and being equidistant with each other. The invention improves the linear response of the electric field by redesigning the plurality of electrodes for each row of conductive silver circuits and the relative positions of any two adjacent conductive silver circuits.

Another objective of the present invention is to reduce the width of the electrode pattern, so as to minimize the external frame of the touch panel and increase the usable area and installation space of the touch panel.

To achieve the foregoing objectives, a feasible method of the invention redesigns the plurality of electrodes for each row of conductive silver circuits and the relative positions of any two adjacent conductive silver circuits and maintains the width of the electrode pattern below 2.8 mm.

### BRIEF DESCRIPTION OF THE DRAWINGS

FIG. 1 is a schematic view of the structure of a capacitive touch panel of the present invention;

FIG. 2 is a schematic view of the positions of electrodes for each row of conductive silver circuits according to a preferred embodiment of an electrode pattern of the present invention;

FIG. 3 is a schematic view of the relative positions of electrodes for each row of conductive silver circuits according to a preferred embodiment of an electrode pattern of the present invention;

FIG. 4 is an equivalent circuit diagram as depicted in FIG. 2;

FIG. 5 is a potential line distribution diagram of one of the corners of the touch panel according to a preferred embodiment of the electrode pattern as depicted in FIG. 2;

FIG. 6 PRIOR ART is an equipotential line distribution diagram as disclosed in U.S. Pat. No. 6,781,579; and

FIG. 7 PRIOR ART is an equipotential line distribution diagram of U.S. Pat. Nos. 4,198,539, 4,293,734 and 4,371,746.

### DETAILED DESCRIPTION OF THE PREFERRED EMBODIMENTS

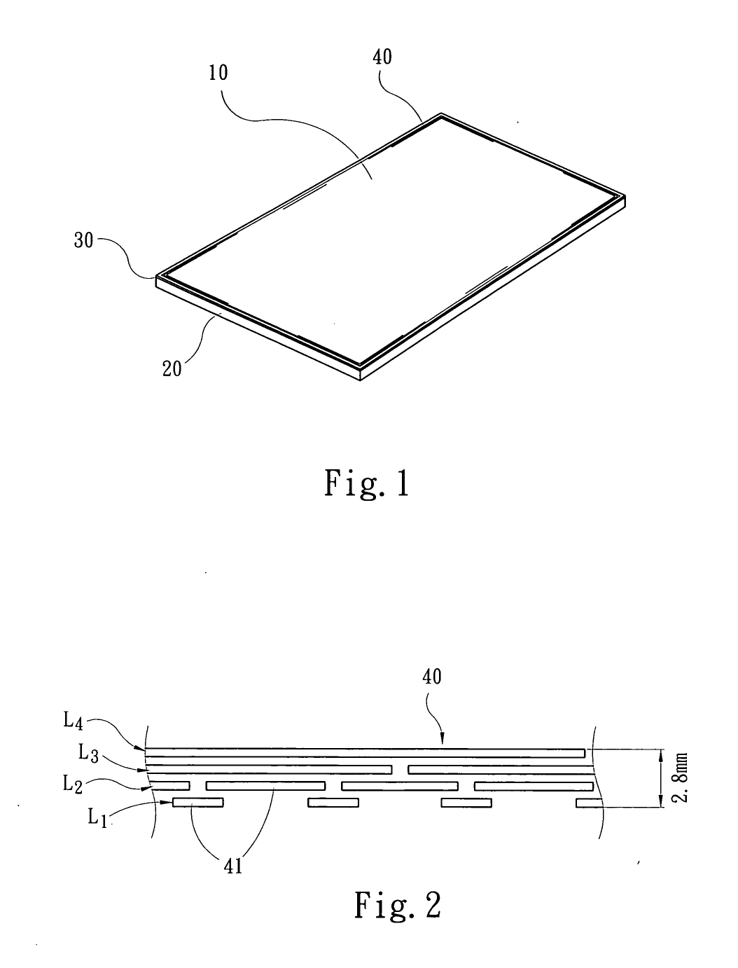

Referring to FIG. 1 for the structure of a capacitive touch panel of the present invention, the capacitive touch panel 10 comprises:

an insulating substrate 20, such as a glass plate;

a conductive layer 30, formed on the surface of the insulating substrate 20, and a common conductive layer 30 is a metal oxide layer; and

an electrode pattern, formed on the surface of the conductive layer 30 and disposed along the edges of the touch panel 10, and the electrode pattern includes a plurality of parallel rows of conductive silver circuits 40, and each row of conductive silver circuits 40 includes a plurality of electrodes 41 (as shown in FIG. 2) with equal length and equidistant with each other.

In a first preferred embodiment of the present invention, the total number of rows of conductive silver circuits 40 is X as shown in FIG. 2, wherein the conductive silver circuits are arranged from a position proximate to the center of the touch panel 10 towards the direction away from the center of the touch panel 10 and named as L1, L2, L3 and L4 respectively, and thus the quantity N of electrodes 41 of any row of conductive silver circuits L1, L2, L3, L4 can be determined by Formulas (1) to (4) as follows:
For Ln=1, the quantity of conductive silver circuits N=2(X−n+2)+3 (Formula 1);
For Ln=2, the quantity of conductive silver circuits N=2(X−n+3)+1 (Formula 2);
For Ln=3, the quantity of conductive silver circuits N=2(X−n+2)+3 (Formula 3);
For Ln=4, the quantity of conductive silver circuits N=2(X−n+3)−1 (Formula 4).

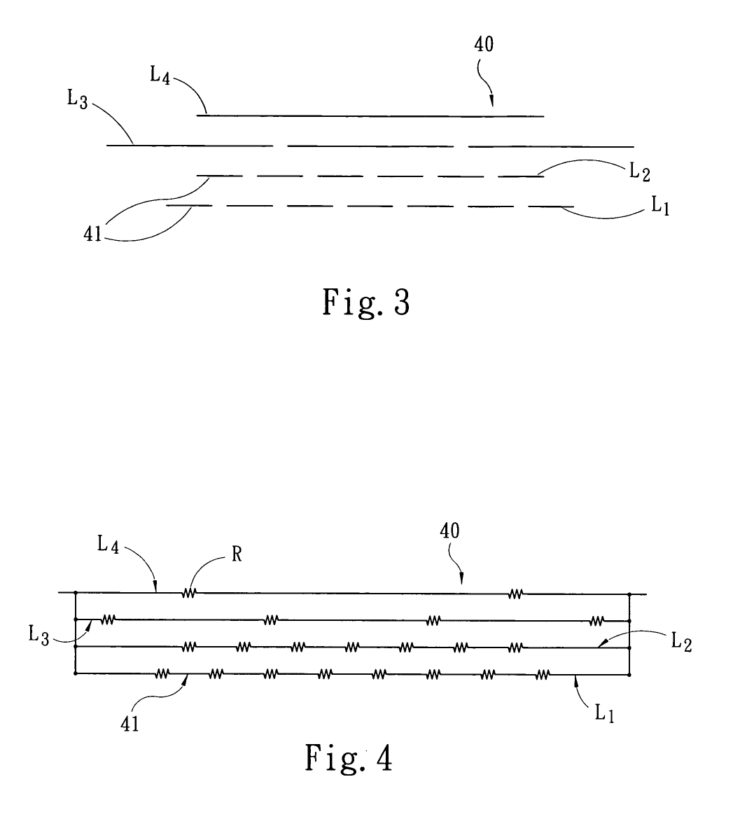

Referring to FIG. 2, the total number of rows of conductive silver circuit 40 of the electrode pattern according to the preferred embodiment of the invention is equal to 4, and the width of the electrode pattern is maintained below 2.8 mm, wherein L1 stands for the row of the conductive silver circuits 40 closest to the center of the touch panel 10, and L2, L3 and L4 stand for the rest three rows of conductive silver circuits 40 arranged sequentially in the direction away from the center of the touch panel 10. The foregoing formulas determine the quantity of electrodes 41 for each row of conductive silver circuits L1, L2, L3 and L4, and the following rules as shown in FIG. 3 are obtained, wherein:

Any one electrode 41 in the conductive silver circuit L2 is jumped to two electrodes 41 in the conductive silver circuit L1;

Any one electrode 41 in the conductive silver circuit L3 is jumped to four electrodes 41 in the conductive silver circuit L2;

Any one electrode 41 in the conductive silver circuit L4 is jumped to three electrodes 41 in the conductive silver circuit L3.

The equivalent circuit shown in FIG. 2 is the same as the one shown in FIG. 4, wherein the resistance symbol R stands for the resistance produced by the conductive layer 30 when any two adjacent electrodes 41 of any one row of conductive silver circuits 40 are electrically connected by the conductive layer 30.

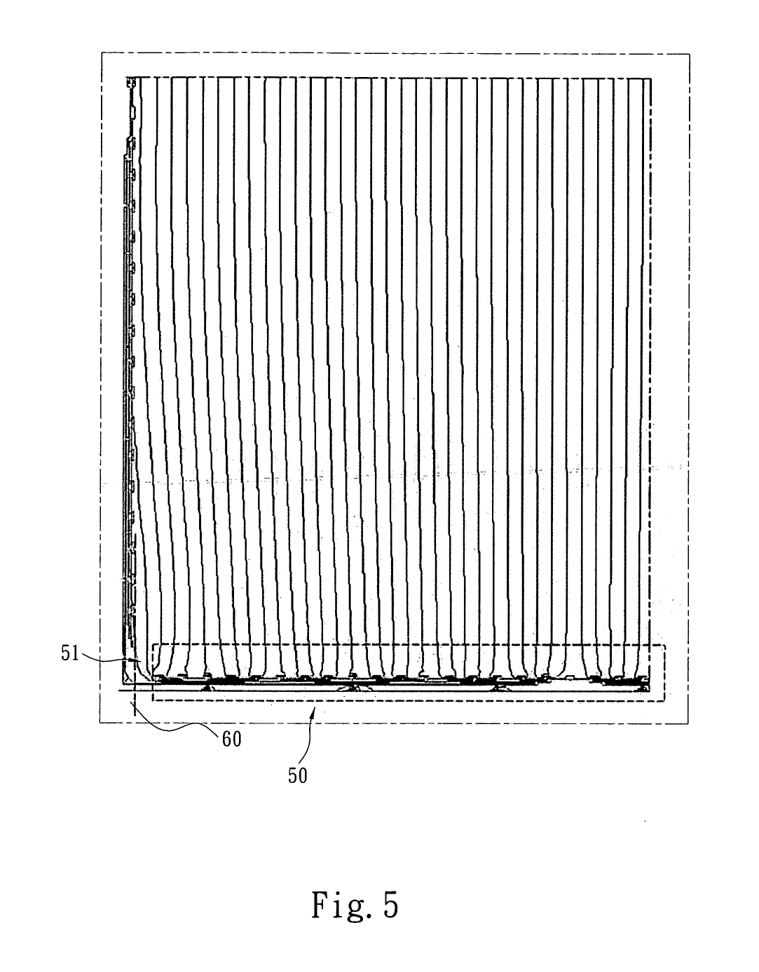

Referring to FIG. 5 for the potential line distribution diagram of one of the corners of the touch panel 10 according to a preferred embodiment of the electrode pattern as depicted in FIG. 2, each line stands for an equipotential line 51 in the electric field. The evener (or the straighter) the distribution, the better is the linear response of the touch panel 10.

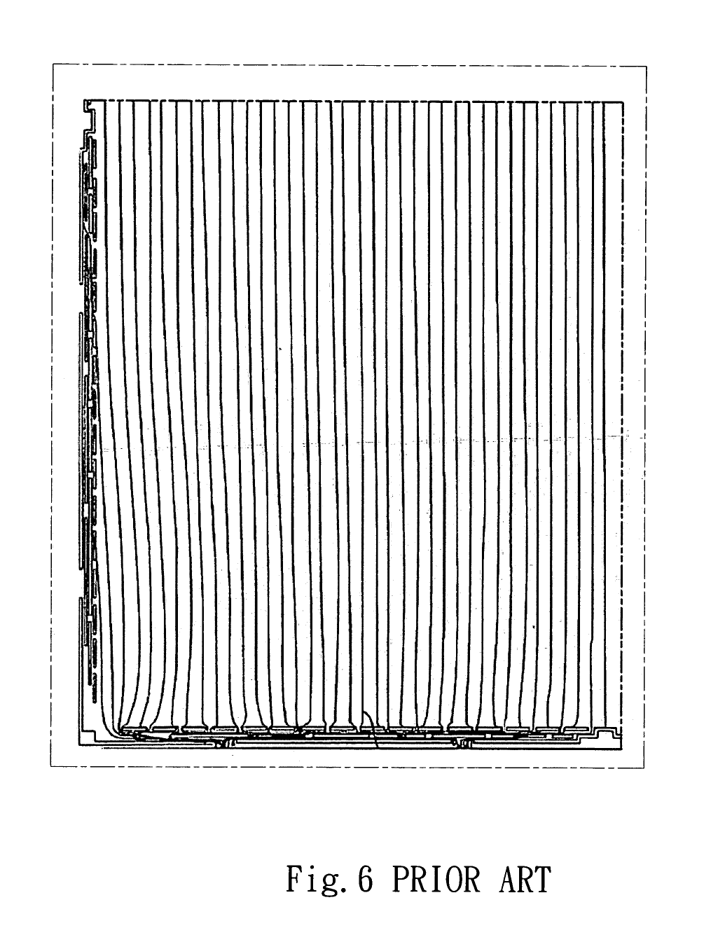

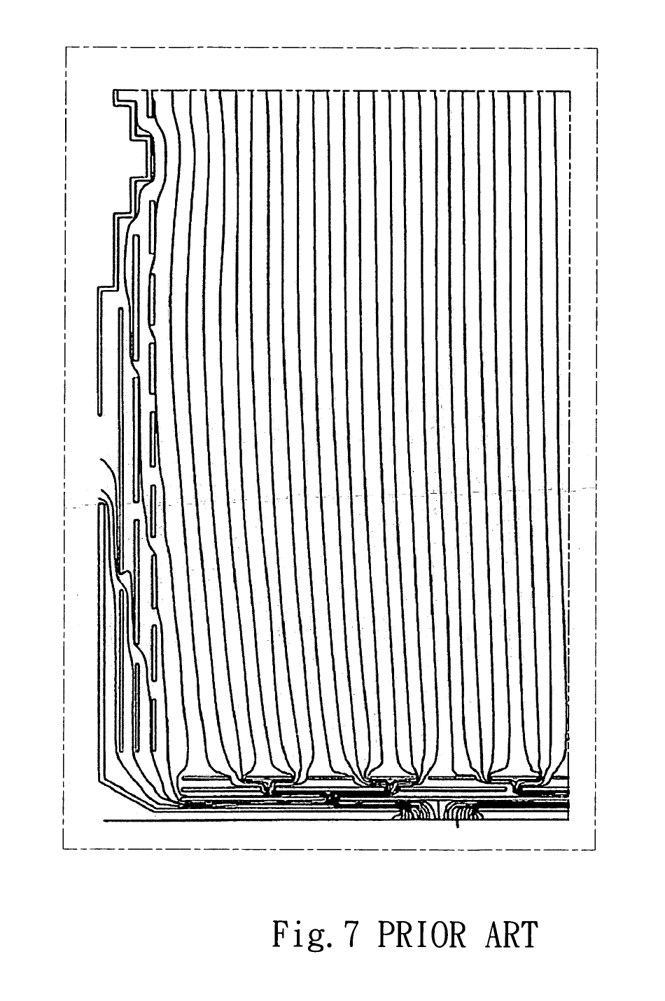

An area enclosed by the dotted lines as shown in FIG. 5 indicates an edge area 50. In general, the evener (or the straighter) the distribution of equipotential lines in the edge area 50, the better is the linear response of the touch panel 10. Compared with the prior arts as disclosed in U.S. Pat. No. 6,781,579 (as shown in FIG. 6 PRIOR ART) and U.S. Pat. Nos. 4,198,539, 4,293,734 and 4,371,746 (as shown in FIG. 7 PRIOR ART), the linear responses of the edge areas of the prior arts as shown in FIG. 6 PRIOR ART and FIG. 7 PRIOR ART are not as good as that of the present invention.

If the equipotential line 51 at the lower left corner of FIG. 5 is close to a reference line 61 which is the central line of the figure, then such equipotential line 51 is closer to the perfect position. On the other hand, if the equipotential line 51 shifts to the right of the reference line 60, then a larger error occurs. Similarly, if we compare the present invention with the prior arts as shown in FIG. 6 PRIOR ART and FIG. 7 PRIOR ART, the equipotential line 51 of the invention at the lower left corner of FIG. 5 is closer to the reference line 60, and thus the linear response of the invention is better than those of the prior arts as shown in FIG. 6 PRIOR ART and FIG. 7 PRIOR ART.

In the foregoing first preferred embodiment of the present invention, the total number of rows of conductive silver circuits 40 is represented by X, which is equal to 4 in this embodiment, and the quantity of electrodes 41 for each row of conductive silver circuits L1, L2, L3, L4 is represented by N and determined by Formulas (1) to (4).

According to a second preferred embodiment of the present invention, the quantity of electrodes 41 in each row of conductive silver circuits 40 is also represented by N and equal to half of the quantity of electrodes of the first preferred embodiment. Similarly, four rows of conductive silver circuits 40 are used for illustration, and the quantity N of electrodes 41 in each row of conductive silver circuits L1, L2, L3, L4 according to the second preferred embodiment of the invention can be determined by Formulas (5) to (8) as follows:
For Ln=1, the quantity of conductive silver circuits N=(2(X−n+2)/2)+1 (Formula 5);
For Ln=2, the quantity of conductive silver circuits N=(2(X−n+3)/2)−1 (Formula 6);
For Ln=3, the quantity of conductive silver circuits N=(2(X−n+2)/2)+1 (Formula 7);
For Ln=4, the quantity of conductive silver circuits N=(2(X−n+3)/2)−1 (Formula 8).

What is claimed is:

1. A capacitive touch panel with improved electrode patterns, comprising:
an insulating substrate;
a conductive layer, formed on the surface of said insulating substrate; and
an electrode pattern, formed on the surface of said conductive layer and disposed along the edges of said touch panel, and said electrode pattern further comprising a plurality of rows of conductive silver circuits, and any one row of said conductive silver circuits including a plurality of electrodes with equal length and equidistant with each other, and the total number of rows of said conductive silver circuits is X, and said conductive silver circuits are named as Ln(n=1˜X) sequentially from a position proximate to the center of said touch panel towards the direction away from the center of said touch panel, and the quantity of electrodes N of any row of said conductive silver circuits is determined by Formulas (1) to (4) as follows:
for Ln=1, the quantity of conductive silver circuits N=2(X−n+2)+3 (Formula 1);
for Ln=2, the quantity of conductive silver circuits N=2(X−n+3)+1 (Formula 2);
for Ln=3, the quantity of conductive silver circuits N=2(X−n+2)+3 (Formula 3); and
for Ln=4, the quantity of conductive silver circuits N=2(X−n+3)−1 (Formula 4).

2. The capacitive touch panel with improved electrode patterns of claim 1, wherein said electrode pattern has a width less than 2.8 mm.

3. The capacitive touch panel with improved electrode patterns of claim 1, wherein any one row of said conductive silver circuits has a quantity of electrodes N determined by Formulas (5) to (8) as follows:
for Ln=1, the quantity of conductive silver circuits N=(2(X−n+2)/2)+1 (Formula 5);
for Ln=2, the quantity of conductive silver circuits N=(2(X−n+3)/2)−1 (Formula 6);
for Ln=3, the quantity of conductive silver circuits N=(2(X−n+2)/2)+1 (Formula 7); and
for Ln=4, the quantity of conductive silver circuits N=(2(X−n+3)/2)−1 (Formula 8).
